(19) United States
(12) Patent Application Publication
(10) Pub. No.: US 2003/0096134 A1
(43) Pub. Date: May 22, 2003

(54) Sliding member for compressor

(75) Inventors: Manabu Sugiura, Kariya-shi (JP); Takahiro Sugioka, Kariya-shi (JP); Akira Onoda, Kariya-shi (JP); Tomohiro Murakami, Kariya-shi (JP); Shino Ohkubo, Kariya-shi (JP)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Kabushiki Kaisha Toyota Jidoshokki

(21) Appl. No.: 10/292,063

(22) Filed: Nov. 12, 2002

(30) Foreign Application Priority Data
Nov. 22, 2001 (JP) 2001-358110

(51) Int. Cl. B32B 15/20

(52) U.S. Cl. 428/652; 428/936

(57) ABSTRACT

A sliding member for a compressor, comprising a base body formed of a material which contains aluminum as a major component, and an electroless nickel plating layer formed on a surface of the base body and containing phosphorous (P) and boron (B), wherein the improvement comprises: the electroless nickel plating layer being a non heat-treated layer containing the phosphorous in an amount of 0.5-5.0 wt. % and the boron in an amount of 0.05-0.2 wt. %.

This application is based on Japanese Patent Application No. 2001-358110 filed Nov. 22, 2001, the contents of which are incorporated hereinto by reference.

### BACKGROUND OF THE INVENTION

1. Field of the Invention

The present invention relates in general to a sliding member for a compressor. In particular, the invention is concerned with such a sliding member capable of exhibiting a high degree of hardness and excellent sliding characteristics such as a high degree of resistance to peeling or removal of a covering or plating layer formed on its surface, and high degrees of resistances to seizure and wear.

2. Discussion of the Related Art

Various kinds of sliding member are used in a compressor such that the sliding member is disposed between a plurality of members for permitting smooth movement relative to each other. One example of such a sliding member is a shoe disposed between a piston and a swash plate of a swash plate type compressor. To avoid seizure and wear of the sliding member formed of a metallic material, due to a sliding contact with other members also formed of a metallic material, the sliding member includes a metal plating layer which is formed on a surface of a base body thereof and which has a hardness higher than that of the base body. JP-A-8-158058 corresponding to U.S. Pat. No. 5,897,965 discloses a mechanical part or member exhibiting good sliding characteristics, wherein at least a sliding portion of its base body formed of an aluminum alloy is covered with an electroless nickel plating layer containing phosphorous and boron. The electroless nickel plating layer was conventionally subjected to a heat treatment for the purpose of improving its hardness.

It has been found that, although the hardness of the electroless nickel plating layer which has been subjected to the heat treatment is improved, the plating layer tends to easily peel off from the surface of the base body after the heat treatment. The reason for this phenomenon is speculated as follows. If the sliding member slides on another member with foreign matters being present therebetween, the plating layer suffers from scratches due to the foreign matters, and cracks tend to generate so as to extend from the scratches. Accordingly, it is considered that portions of the plating layer may peel off from the base body due to the cracks. Pieces of the plating layer which have peeled off from the base body are, in turn, present as foreign matters between the sliding surfaces of the members, so that the plating layer suffers from more scratches, resulting in an undesirably increased tendency of peeling of the plating layer from the base body. In the end, seizure takes place between the sliding surfaces of the members. It is speculated that the cracks take place because the capability of the plating layer for permitting deformation or elongation thereof (deformability) is deteriorated due to the heat treatment.

### SUMMARY OF THE INVENTION

It is therefore an object of the present invention to provide a sliding member which satisfies requirements for high hardness and high resistance to peeling of a covering or plating layer formed on its surface. The object may be achieved according to any one of the following modes of the present invention, each of which is numbered like the appended claims and depends from the other mode or modes, where appropriate, to indicate and clarify possible combinations of elements or technical features of the present invention, for easier understanding of the invention. It is to be understood that the present invention is not limited to the technical features or any combinations thereof which will be described for illustrative purpose only. It is to be further understood that a plurality of elements or features included in any one of the following modes of the invention are not necessarily provided all together, and that the invention may be embodied without some of the elements or features described with respect to the same mode.

(1) A sliding member for a compressor, comprising a base body formed of a material which contains aluminum as a major component, and an electroless nickel plating layer formed on a surface of the base body and containing phosphorous (P) and boron (B), wherein the improvement comprises: the electroless nickel plating layer being a non heat-treated layer containing the phosphorous in an amount of 0.5-5.0 wt. % and the boron in an amount of 0.05-0.2 wt. %.

The electroless nickel plating layer is formed by a known chemical plating method. The base body of the sliding member is immersed in a plating liquid which is accommodated in a plating bath, so that the electroless nickel plating layer is formed on the surface of the base body. The electroless nickel plating layer whose phosphorous content is less than 0.5 wt. % can not be formed by immersing the base body in the plating liquid which contains hypophosphorous acid as a reducing agent. On the contrary, the electroless nickel plating layer whose phosphorous content exceeds 5.0 wt. % undesirably has insufficient hardness. If the boron content in the electroless nickel plating layer is less than 0.05 wt. %, the hardness of the plating layer is insufficient. On the contrary, if the electroless nickel plating layer whose boron content exceeds 0.2 wt. % is formed by the chemical plating method, the plating layer is formed on undesirable portions other than the base body of the sliding member. For instance, the plating layer is formed on the inner wall surface of the plating bath, and a mass of particles accumulated on the bottom of the plating bath. The inventors of the present invention have found that if the electroless nickel plating layer is formed such that the phosphorous content and the boron content are held within the respective ranges specified above according to the present invention and the electroless nickel plating layer is not subjected to any heat treatment, the plating layer can be formed with high stability on the base body of the sliding member, which sliding member exhibits a sufficiently high degree of hardness suitable for a practical use in the compressor. Further, it is also found that the electroless nickel plating layer which has not been subjected to the heat treatment does not suffer from cracks which result from scratches generated while the electroless nickel plating layer slides on another member, so that the plating layer is prevented from peeling off from the base body due to the cracks. Accordingly, the peel-off resistance of the plating layer is improved. The present invention has been made based on the findings described above. The principle of the invention is particularly preferably applicable to shoes for a swash plate type compressor, vanes or side plates for a vane compressor, and scrolls for a scroll type compressor, for example.

(2) A sliding member according to the above mode (1), wherein the electroless nickel plating layer contains the phosphorous in an amount of 0.5-3.0 wt. %.

If the amount of the phosphorous contained in the electroless nickel plating layer is held within the range specified in the mode (2), the hardness of the plating layer can be maintained at a relatively high level with high stability.

(3) A sliding member according to the above mode (1) or (2), wherein the electroless nickel plating layer contains the boron in an amount of 0.05-0.18 wt. %.

The plating layer which contains the boron in an amount held within the range specified in the mode (3) can be easily formed with high stability.

(4) A sliding member according to the above mode (1) or (2), wherein the electroless nickel plating layer contains the boron in an amount of 0.05-0.14 wt. %.

(5) A sliding member according to any one of the above modes (1)-(4), wherein the sliding member further comprises an electroless Ni—P plating layer formed between the base body and the electroless nickel plating layer.

The electroless Ni—P plating layer formed between the base body and the electroless nickel plating layer functions as an undercoat layer for increasing adhesion between the base body and the electroless nickel plating layer, so as to prevent peeling or removal of the electroless nickel plating layer from the base body. The electroless Ni—P plating layer also functions as a cushioning or shock-absorbing layer for absorbing shock applied to the electroless nickel plating layer. Thus, the present arrangement is effective to prevent chipping and peeling or removal of the electroless nickel plating layer from the base body, so that the sliding member maintains its sliding characteristics for a long time period of service, resulting in improvement in the durability of the sliding member. The electroless Ni—P plating layer in the present invention contains P as a major additive to Ni which is the major component of the Ni—P plating layer. Further, the electroless Ni—P plating layer may contain other additives in addition to P, as long as the Ni—P plating layer including the other additives maintain its function as the undercoat layer or the cushioning layer.

(6) A sliding member according to the above mode (5), wherein the electroless Ni—P plating layer contains phosphorous in an amount of 5.0-15.0 wt. %.

If the amount of the phosphorous contained in the electroless Ni—P plating layer is held within the range specified in the mode (6), the Ni—P plating layer effectively functions as the cushioning or shock-absorbing layer.

(7) A sliding member according to any one the above modes (1)-(6), which is a shoe used for a swash plate type compressor.

The-shoe used for the swash plate type compressor is required to exhibit high degrees of hardness and resistance to wear since the shoe is disposed between the piston and the swash plate for sliding on the piston and the swash plate. In addition, since the foreign matters tend to get in between the piston and the shoe, or between the swash plate and the shoe, it is particularly required that the plating layer of the shoe does not peel off from the base body even if the plating layer suffers from scratches due to the foreign matters. If the electroless nickel plating layer according to the present invention is formed on the surface of the base body of the shoe, the shoe exhibits high degrees of hardness and wear resistance without suffering from the peeling of the electroless nickel plating layer from its base body.

(8) A sliding device according to any one of the above modes (1)-(6), which is a vane used for a vane compressor.

As described below in greater detail, the vane used for the vane compressor is slidably fitted in a corresponding one of vane grooves formed in a rotor. The radially outer end face of the vane is held in sliding contact with the inner surface of the cylinder while the opposite side surfaces of the vane are held in sliding contact with a front and rear side plates, respectively. Thus, the vane is required to exhibit high degrees of hardness and resistance to wear. In addition, since the foreign matters tend to get in between the vane and the rotor, between the vane and the cylinder, or between the vane and side plates, it is particularly required that the plating layer formed on the surface of the vane does not peel off even if the plating layer suffers from scratches due to the foreign matters. If the electroless nickel plating layer according to the present invention is formed on the surface of the base body of the vane, the vane exhibits high degrees of hardness and wear resistance without suffering from peeling of the plating layer from its base body.

### BRIEF DESCRIPTION OF THE DRAWINGS

The above and optional objects, features, advantages and technical and industrial significance of the present invention will be better understood and appreciated by reading the following detailed description of presently preferred embodiments of the invention, when considered in connection with the accompanying drawings, in which:

FIG. 1 is a front elevational view in cross section of a swash plate type compressor which is equipped with shoes each as a sliding member according to one embodiment of the present invention;

FIG. 2 is an enlarged front elevational view in cross section showing the shoe used in the swash plate type compressor;

FIG. 3 is a graph showing results of a test for examining the hardness of various shoes having different boron contents of the electroless nickel plating layers thereof;

FIG. 4 is a graph showing a relationship between the boron content of the electroless nickel plating layer and the number of turns of the plating liquid, obtained for various shoes having different boron contents;

FIG. 5 is a graph showing a relationship between the hardness of the electroless nickel plating layer and the number of turns of the plating liquid, obtained for various shoes having different boron contents;

FIG. 6 indicates results of tests conducted on the non heat-treated electroless nickel plating layer according to the present invention and the heat-treated electroless nickel plating layer as a comparative example, for examining the resistance of the plating layers to peeling;

FIG. 7 is a front elevational view in cross section of a vane compressor equipped with vanes each as a sliding member according to another embodiment of the invention: and

FIG. 8 is a side elevational view in cross section of the vane compressor of FIG. 7.

### DETAILED DESCRIPTION OF THE PREFERRED EMBODIMENTS

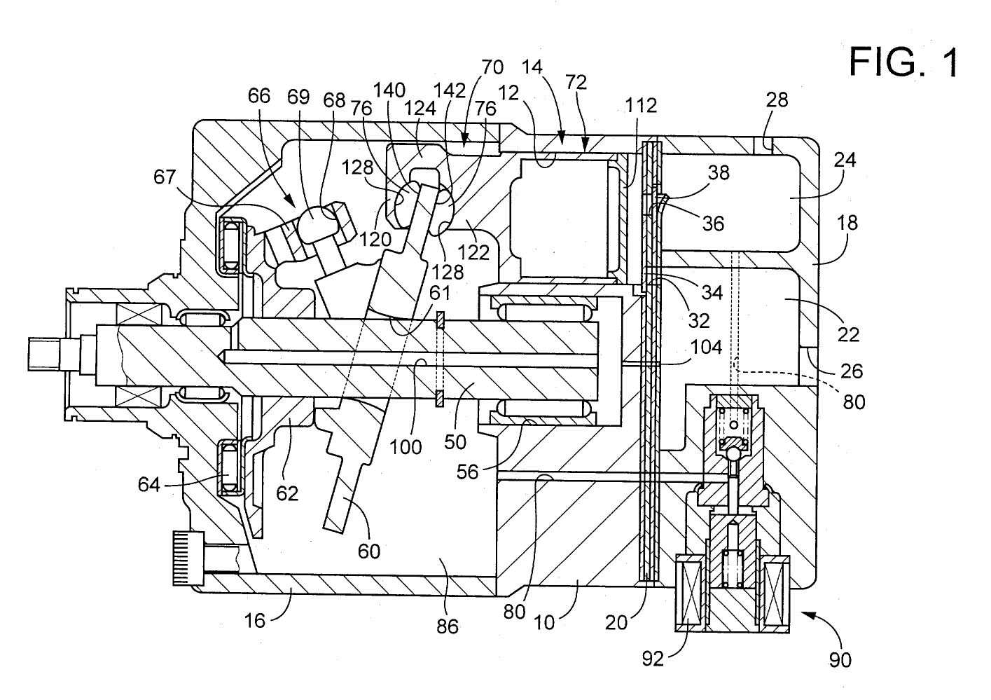

Referring to the accompanying drawings, there will be described a presently preferred embodiment of this invention as applied to a shoe installed on a swash plate type compressor as a refrigerant compressor used for an air conditioning system of an automotive vehicle. Referring first to FIG. 1, there is shown a compressor of swash plate type. In FIG. 1, reference numeral 10 denotes a cylinder block having a plurality of cylinder bores 12 formed so as to extend in its axial direction such that the cylinder bores 12 are arranged along a circle whose center lies on a centerline of the cylinder block 10. Single-headed pistons generally indicated at 14 (hereinafter simply referred to as “piston 14”) are reciprocably received in the respective cylinder bores 12. To one of the axially opposite end faces of the cylinder block 10, (the left end face as seen in FIG. 1, which will be referred to as “front end face”), there is attached a front housing 16. To the other end face (the right end face as seen in FIG. 1, which will be referred to as “rear end face”), there is attached a rear housing 18 through a valve plate 20. The front housing 16, rear housing 18 and cylinder block 10 cooperate to constitute a housing assembly of the swash plate type compressor. The rear housing 18 and the valve plate 20 cooperate to define a suction chamber 22 and a discharge chamber 24, which are connected to a refrigerating circuit (not shown) through an inlet 26 and an outlet 28, respectively. The valve plate 20 has suction ports 32, suction valves 34, discharge ports 36 and discharge valves 38.

A rotary drive shaft 50 is disposed in the cylinder block 10 and the front housing 16 such that the axis of rotation of the drive shaft 50 is aligned with the centerline of the cylinder block 10. The drive shaft 50 is supported at its opposite end portions by the front housing 16 and the cylinder block 10, respectively, via respective bearings, such that the drive shaft 50 is rotatable relative to the front housing 16 and the cylinder block 10. The cylinder block 10 has a central bearing hole 56 formed in a central portion thereof, and the bearing is disposed in this central bearing hole 56, for supporting the drive shaft 50 at its rear end portion. The front end portion of the drive shaft 50 is connected, through a clutch mechanism such as an electromagnetic clutch, to an external drive source (not shown) in the form of an engine of an automotive vehicle. In operation of the compressor, the drive shaft 50 is connected through the clutch mechanism to the vehicle engine in operation so that the drive shaft 50 is rotated about its axis.

The rotary drive shaft 50 carries a swash plate 60 such that the swash plate 60 is axially movable and tiltable relative to the drive shaft 50. The swash plate 60 has a central hole 61 through which the drive shaft 50 extends. The inner dimension of the central hole 61 as measured in the vertical direction of FIG. 1 gradually increases in the direction from the axially intermediate portion toward each of the axially opposite ends, and the transverse cross sectional shape of the central hole 61 at each of the axially opposite ends is elongated. To the drive shaft 50, there is fixed a rotary member 62 as a torque transmitting member, which is held in engagement with the front housing 16 through a thrust bearing 64. The swash plate 60 is rotated with the drive shaft 50 by a hinge mechanism 66 during rotation of the drive shaft 50. The hinge mechanism 66 guides the swash plate 60 for its axial and tilting motions. The hinge mechanism 66 includes a pair of support arms 67 fixed to the rotary member 62, guide pins 69 which are formed on the swash plate 60 and which slidably engage guide holes 68 formed in the support arms 67, the central hole 61 of the swash plate 60, and the outer circumferential surface of the drive shaft 50.

The piston 14 indicated above includes an engaging portion 70 engaging the radially outer portion of the opposite surfaces of the swash plate 60, and a head portion 72 formed integrally with the engaging portion 70 and slidably fitted in the corresponding cylinder bore 12. The head portion 72 of the piston 14 in the present embodiment is made hollow, for thereby reducing the weight of the piston 14. The head portion 72, cylinder bore 12, and valve plate 20 cooperate with one another to define a pressurizing chamber. The engaging portion 70 engages the radially outer portion of the opposite surfaces of the swash plate 60 through a pair of part-spherical-crown shoes 76. The shoes 76 will be described in greater detail. The piston 14 in the present embodiment has a single head portion 72 at one of its opposite ends, and is referred to as the single-headed piston.

The piston 14 is reciprocated by rotation of the swash plate 60. Described in detail, a rotary motion of the swash plate 60 is converted into a reciprocating linear motion of the piston 14 through the shoes 76. A refrigerant gas in the suction chamber 22 is sucked into the pressurizing chamber of the cylinder bore 12 through the suction port 32 and the suction valve 34, when the piston 14 is moved from its upper dead point to its lower dead point, that is, when the piston 14 is in the suction stroke. The refrigerant gas in the pressurizing chamber of the cylinder bore 12 is pressurized by the piston 14 when the piston 14 is moved from its lower dead point to its upper dead point, that is, when the piston 14 is in the compression stroke. The pressurized refrigerant gas in the pressurizing chamber is discharged into the discharge chamber 24 through the discharge port 36 and the discharge valve 38. A reaction force acts on the piston 14 in the axial direction as a result of compression of the refrigerant gas in the pressurizing chamber. This compression reaction force is received by the front housing 16 through the piston 14, swash plate 60, rotary member 62 and thrust bearing 64.

The cylinder block 10 has an intake passage 80 formed therethrough for communication between the discharge chamber 24 and a crank chamber 86 which is defined between the front housing 16 and the cylinder block 10. The intake passage 80 is connected to a solenoid-operated control valve 90 provided to control the pressure in the crank chamber 86. The solenoid-operated control valve 90 includes a solenoid coil 92. The amount of electric current applied to the solenoid coil 92 is controlled depending upon the air conditioner load by a control device not shown constituted principally by a computer.

The rotary drive shaft 50 has a bleeding passage 100 formed therethrough. The bleeding passage 100 is open at one of its opposite ends to the central bearing hole 56, and is open at the other end to the crank chamber 86. The central bearing hole 56 communicates at its bottom with the suction chamber 22 through a communication port 104.

The present swash plate type compressor is of variable capacity type. By controlling the pressure in the crank chamber 86 by utilizing the difference between the pressure in the discharge chamber 24 as a high-pressure source and the pressure in the suction chamber 22 as a low pressure source, the difference between the pressure in the pressurizing chamber of the cylinder bore 12 and the pressure in the crank chamber 86 is regulated to change the angle of inclination of the swash plate 60 with respect to a plane perpendicular to the axis of rotation of the drive shaft 50, for thereby changing the reciprocating stroke (suction and compression strokes) of the piston 14, whereby the displacement capacity of the compressor can be adjusted. Described in detail, by energization and de-energization of the solenoid coil 92 of the solenoid-operated control valve 90, the crank chamber 86 is selectively connected to and disconnected from the discharge chamber 24, so that the pressure in the crank chamber 86 is controlled. The swash plate inclination angle changing device for changing the inclination angle of the swash plate in the present embodiment is constituted by the hinge mechanism 66, cylinder bores 12, pistons 14, suction chamber 22, discharge chamber 24, central bearing hole 56, crank chamber 86, bleeding passage 100, communication port 104, control device not shown, etc.

The cylinder block 10 and each piston 14 are formed of an aluminum alloy. The piston 14 is coated at its outer circumferential surface with a fluoro resin film which prevents direct contact of the aluminum alloy of the piston 14 with the aluminum alloy of the cylinder block 10 so as to prevent seizure therebetween, and makes it possible to minimize the amount of clearance between the piston 14 and the cylinder bore 12. Other materials may be used for the cylinder block 10, the piston 14, and the coating film.

The end portion of the engaging portion 70 of the piston 14, which is remote from the head portion 72, has a U-shape in cross section. Described in detail, the engaging portion 70 has a base section 124 which defines the bottom of the U-shape, and a pair of substantially parallel arm sections 120, 122 which extend from the base section 124 in a direction perpendicular to the axis of the piston 14. The two opposed lateral walls of the U-shape of the engaging portion 70 have respective recesses 128 which are opposed to each other. Each of these recesses 128 is defined by a part-spherical inner surface of the lateral wall. The part-spherical inner surfaces of the recesses 128 are located on the same spherical surface.

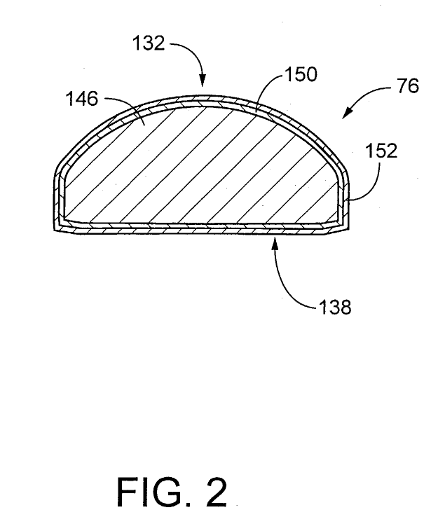

As shown in FIG. 2, each of the pair of shoes 76 has a substantially part-spherical crown shape, and includes a generally convex part-spherical surface 132 and a generally flat surface 138. The pair of shoes 76 slidably engage the part-spherical inner surfaces of the recesses 128 of the piston 14 at their part-spherical surfaces 132 and slidably engage the radially outer portion of the opposite surfaces of the swash plate 60, i.e., sliding surfaces 140, 142 of the swash plate 60, at their flat surfaces 138. The pair of shoes 76 are designed such that their convex part-spherical surfaces 132 are located on the same spherical surface. In other words, each shoe 76 has a part-spherical crown shape whose size is smaller than the hemisphere by the amount corresponding to a half of the thickness of the swash plate 60. The shape of the shoe is not limited to that described above.

The shoe 76 includes a base body 146 and covering layers in the form of a first hard layer 150 and a second hard layer 152 which are formed on the outer surface of the base body 146 in the order of description. Described more specifically, the base body 146 of the shoe 76 is formed of an aluminum alloy (such as A4032 according to JIS H 4100) which contains aluminum as a major component, and silicon. The first hard layer 150 entirely covers the outer surface of the base body 146 of the shoe 76 while the second hard layer 152 entirely covers the outer surface of the first hard layer 150. In FIG. 2, the thickness of each of the first and second hard layers 150, 152 is exaggerated for easier understanding. The first hard layer 150 may be formed by electroless plating of a nickel-based composition. For instance, the first hard layer 150 is provided by a nickel-based plating layer selected from a Ni—P layer, a Ni—B layer, a Ni—P—B layer, and a Ni—P—B—W layer. In the present embodiment, the first hard layer 150 is the electroless Ni—P plating layer.

The second hard layer 152 is an electroless Ni—P—B plating layer. The electroless plating layers such as the Ni—P plating layer and the Ni—P—B plating layer are formed by a known chemical plating method. In the chemical plating method, the base body 146 of the shoe 76 is immersed in a plating liquid accommodated in a plating vessel (plating bath), for thereby forming the first hard layer 150 on the base body 146. Similarly, the second hard layer 152 is formed on the first hard layer 150. The plating liquid contains a reducing agent for reducing nickel ions in the plating liquid so as to deposit nickel. The deposited nickel adheres to the base body 146 so as to form the plating layers 150, 152. As the reducing agent, hypophosphorous acid which contains phosphorous, and dimethylamine borane which contains boron may be used. According to the chemical plating method, the two plating layers (i.e., the first and second hard layers 150, 152), each of which has a uniform thickness, can be easily formed on the base body 146 of the shoe 76 by using a simple device.

The second hard layer 152 is formed such that the content of phosphorous is held within a range of 0.5-5.0 wt. %, preferably in a range of 0.5-3.0 wt. %, and such that the content of boron is held within a range of 0.05-0.2 wt. %, preferably in a range of 0.05-0.18 wt. %. In the present invention, the second hard layer 152 is a non heat-treated layer, so that the second hard layer 152 does not suffer form a decrease in its deformability, which would be otherwise caused by the heat treatment. Accordingly, the second hard layer 152 is prevented from peeling off from the base body 146 even when the second plating layer 152 suffers from scratches caused by the foreign matters which get in between the shoe 76 and the piston 14 or between the shoe 76 and the swash plate 60. The first hard layer 150 contains 5.0-15.0 wt. % of phosphorous. Preferably, the first hard layer 150 in the form of the electroless Ni—P plating layer contains 8.0 wt. % of phosphorous. The second hard layer 152 in the form of the electroless Ni—P—B plating layer preferably contains 2.0 wt. % of phosphorous and 0.1 wt. % of boron. The electroless Ni—P—B plating layer may further contain about 0.09 wt. % of tungsten (W). The content of tungsten is held preferably in a range of 0.01-0.3 wt. %, and more preferably in a range of 0.02-0.2 wt. %.

The first and second hard layers 150, 152 formed on the base body 146 of each shoe 76 effectively prevent seizure due to the sliding contact between the part-spherical surface 132 of the shoe 76 and the recess 128 of the piston 14, the shoe 76 and the piston 14 being formed of similar metallic materials (the aluminum alloy). The first and second hard layers 150, 152 are also effective to prevent seizure between the flat surface 138 of the shoe 76 and the corresponding sliding surface 140, 142 of the swash plate 60. In the present embodiment, the base body 146 of each shoe 76 formed of the material that is principally constituted by aluminum is covered with the first hard layer 150 and the second hard layer 152 which are harder than the base body 146 of the shoe 76. According to this arrangement, the strength of the shoe 76 is increased, so that the durability of the shoe 76, and accordingly the durability of the swash plate type compressor including the piston 14 can be improved.

As described above, the first hard layer 150 (the Ni—P plating layer in the present embodiment) provided between the base body 146 of the shoe 76 and the second hard layer 152 (the Ni—P—B plating layer in the present embodiment) functions as an undercoat layer and a cushioning layer, so as to prevent chipping and peeling of the second hard layer 152 from the base body 146. Accordingly, the shoe 76 maintains its slidability and durability for a long time period of service.

The first and second hard layers 150, 152 may be formed on at least a portion of the shoe 76, which portion is to be subjected to particularly severe sliding conditions.

While the presently preferred embodiment of this invention has been described above, for illustrative purpose only, it is to be understood that the present invention is not limited to the details of the illustrated embodiment. For instance, the principle of the invention is applicable to a swash plate type compressor equipped with double-headed pistons each having head portions on the opposite sides of the engaging portion, or a swash plate type compressor of fixed capacity type.

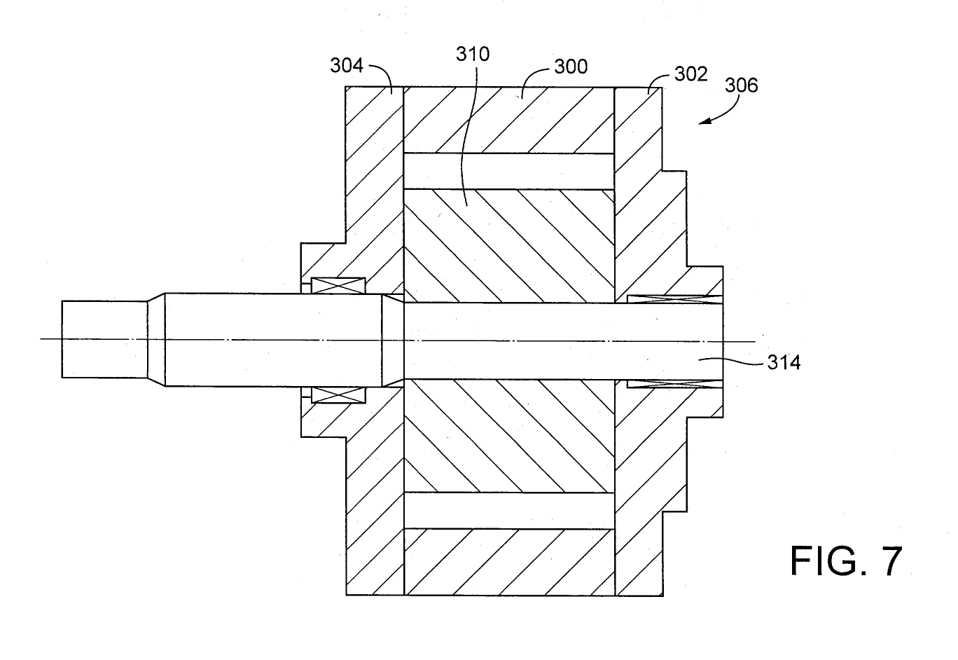

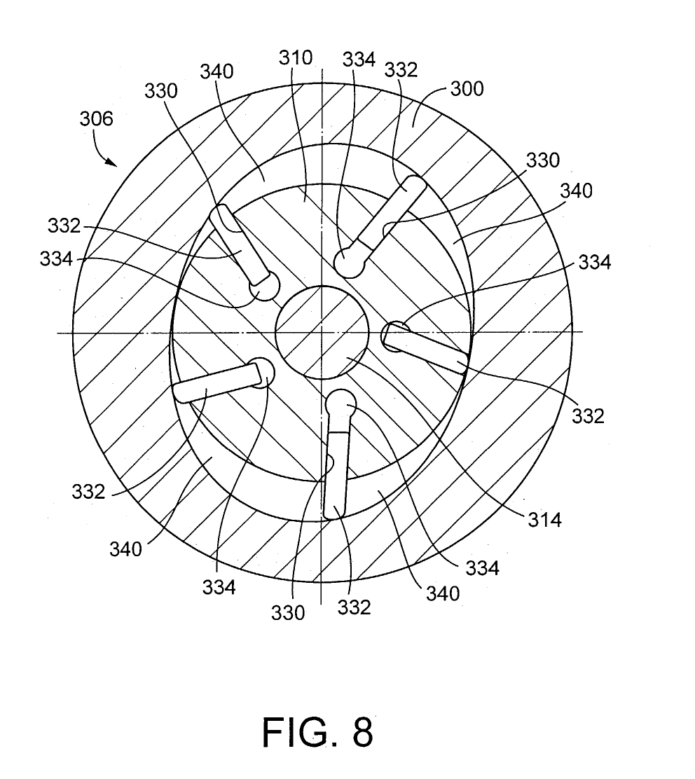

The sliding member according to the present invention may be used as a vane for a vane compressor. There will be described a second embodiment of the invention as applied to the vane installed on the vane compressor. FIGS. 7 and 8 schematically show one example of the vane compressor. The vane compressor includes a generally tubular cylinder 300, and a rear and a front side plate 302, 304, which side plates 302, 304 are respectively fixed to axially opposite ends of the cylinder 300, so as to constitute a cylinder assembly 306 of the compressor. A rotor 310 is rotatably disposed within a space defined by the cylinder 300 and the rear and front side plates 302, 304. A rotary drive shaft 314 which is connected to a drive source not shown is rotatably disposed in the cylinder assembly 306 of the compressor such that the axis of rotation of the drive shaft 314 is aligned with the centerline of the cylinder assembly 306. The rotor 310 is mounted on the drive shaft 314. As shown in FIG. 8, the inner surface of the cylinder 300 is formed such that a radial distance from the axis of rotation of the drive shaft 314 continuously and smoothly changes, i.e., increases and decreases, in the rotating direction of the drive shaft 314, so that the inner surface of the cylinder 300 has an oval or elliptical shape in transverse cross section. The rotor 310 is disposed within the above-described space defined by the cylinder 300 and the rear and front side plates 302, 304, such that two portions of the rotor 310 which are diametrically opposite to each other in the direction of the minor axis of the ellipse are held in contact with the inner elliptical surface of the cylinder 300. Further, axially opposite end faces of the rotor 310 are held in contact with the inner surfaces of the respective rear and front side plates 302, 304. According to this arrangement, two generally crescent-shaped spaces are defined by the cylinder assembly 306 of the compressor and the rotor 310.

As shown in FIG. 8, the rotor 310 has a plurality of vane grooves 330 (five grooves in this embodiment) which are spaced from each other in the circumferential direction of the rotor 310. Each of the grooves 330 is open in the outer circumferential surface of the rotor 310. Five vanes 332 are slidably received in the respective grooves 330. The vanes 332, the rotor 310, and the rear and front side plates 302, 304 cooperate to define a plurality of back-pressure chambers 334 (five back-pressure chambers in this embodiment), each of which is located on the side of the radially inner end of the vane 332. The vanes 332 are forced to be pushed in the radially outward direction by the pressure of a highly pressurized refrigerant gas including the lubricating oil, introduced into the back-pressure chambers 334, in addition to the centrifugal force generated by rotation of the rotor 310. While the rotor 310 is rotated, the radially outer end faces of the vanes 332 slide on the inner elliptical surface of the cylinder 300. Accordingly, the volume of each of a plurality of fluid-tight compression chambers 340 (five compression chambers in this embodiment) changes (i.e., increases and decreases) while the rotor 310 is rotated. Each compression chamber 340 is defined by adjacent two vanes 332, the cylinder assembly 306, and the rotor 310. Each compression chamber 340 is brought into communication alternately with suction ports (not shown) connected to a low-pressure chamber, and discharge ports (not shown) connected to a high-pressure chamber formed in the cylinder assembly 306 of the compressor. The refrigerant gas is compressed as a result of the change of the volume of the compression chambers 340.

In the thus constructed vane compressor, the radially outer end faces of the vanes 332 and the inner elliptical surface of the cylinder 300, the side surfaces of the vane 332 and the inner surfaces of the rear and front side plates 302, 304, and the opposite surfaces of each vane 332 and the inner surface of the corresponding vane groove 330, slide on each other while the rotor 310 is rotated. Accordingly, it is required that the vane 332 exhibits high degrees of hardness and wear resistance. In addition, it is particularly required that the plating layer formed on the surface of the vane 332 does not peel off therefrom even when the vane 332 suffers from scratches on its surface due to the foreign matters which get in between the opposite surfaces of the vane 332 and the inner surface of the groove 330, between the radially outer end faces of the vane 332 and the inner elliptical surface of the cylinder 300, and between the side surfaces of the vane 332 and the inner surfaces of the rear and front side plates 302, 304. Where the base body of the vane 332 is formed of a material that contains aluminum as a major component for reduction of the weight of the vane, the vane 332 exhibits high degrees of hardness and peel-off resistance of the plating layer formed on the surface of the base body if the surface of the base body is covered with the hard layer 152 (and the hard layer 150) described above with respect to the first embodiment directed to the shoe of the swash plate type compressor. Each of the cylinder 300, rear and front side plates 302, 304; rotor 310, etc., of the vane compressor may be considered as a sliding member. The surface of each of those components of the vane compressor may be covered with the electroless nickel plating layer according to the present invention, so that those components exhibit high degrees of hardness and wear resistance.

It is to be understood that the present invention may be embodied with various changes and improvements such as those described in the SUMMARY OF THE INVENTION, which may occur to those skilled in the art.

<Experiments>

The following experiments were conducted on the shoe 76 as the sliding member installed on the swash plate type compressor described in the DETAILED DESCRIPTION OF THE PREFERRED EMBODIMENT for examining a relationship between the content of the boron included in the Ni—P-B plating layer and the hardness (the Vickers Hardness HV) of the plating layer, and the influence of a heat treatment on the peel-off resistance of the Ni—P—B plating layer from the base body of the shoe 76.

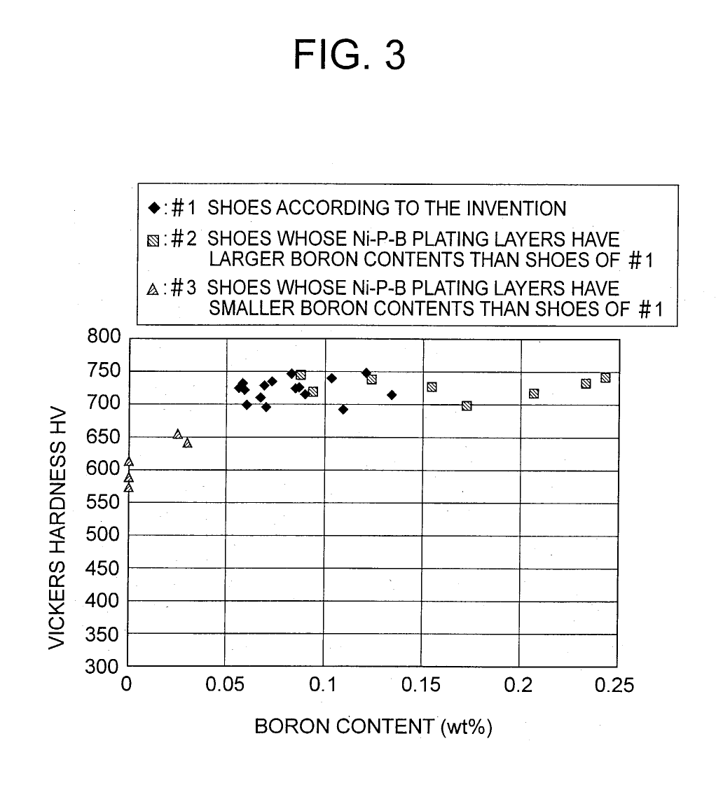

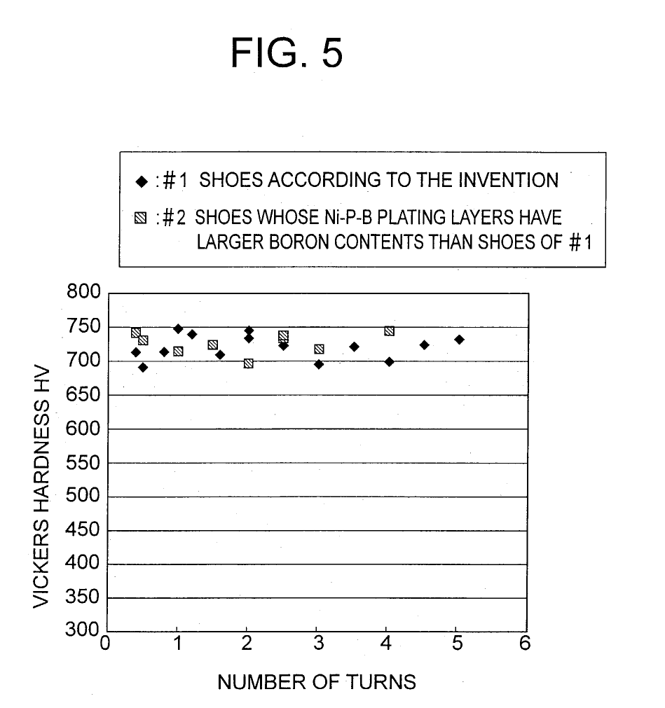

Initially, an intermediate product of the shoe 76, in other words, the base body 146 on which the hard layer 150 had been formed, was immersed in a plating liquid for forming a Ni—P—B plating layer, so that the hard layer 152 (the Ni—P—B plating layer) was formed on the surface of the intermediate product. Thus, the shoe 76 as an end product was obtained without effecting a heat treatment thereon. The thus formed shoe 76 was used in the following experiments, and the results of the experiments are indicated in the graphs of FIGS. 3-5. The experiments were conducted on a plurality of shoes having different contents of boron included in the Ni—P—B plating layer. The plurality of shoes are classified into three groups #1-#3. In the graphs of FIGS. 3-5, the shoes in the groups #1, #2, and #3 are respectively indicated by rhombic symbol (“♦”), square symbol (“□”), and triangular symbol (“Δ”). The shoes in the group #1 are produced according to the present invention, and have the Ni—P—B plating layers containing respective different amounts of boron in a range of 0.05-0.14 wt. %. The shoes in the group #2 are comparative shoes which have the Ni—P—B plating layers having respective different boron contents which are larger than those in the shoes of the group #1. Described in detail, the Ni—P—B plating layers of the shoes of the group #2 were formed by using a plating liquid containing dimethylamine borane (as a reducing agent including boron) in the amount twice as large as that in a plating liquid for forming the Ni—P—B layers of the shoes of the group #1. The shoes in the group #3 are also comparative shoes which have the Ni—P—B layers having respective different boron contents smaller than 0.05 wt. % (including 0 wt. %).

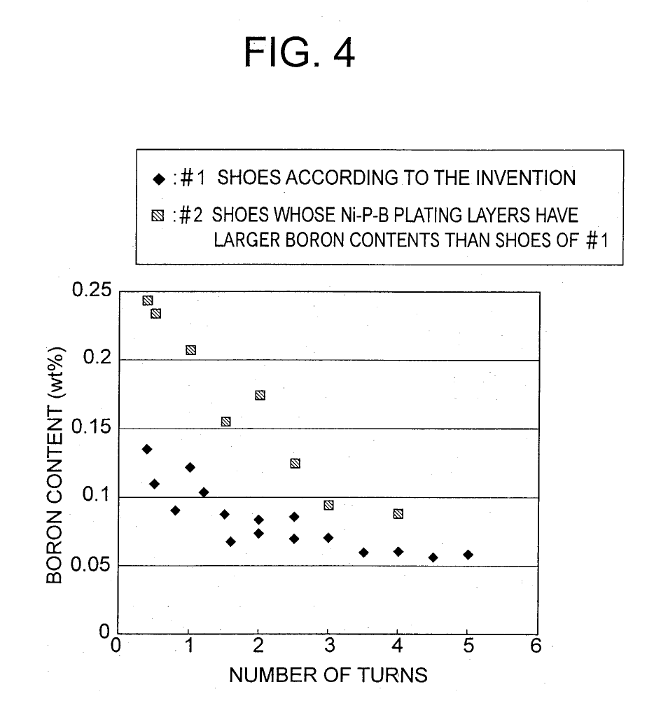

In the experiments, there were examined the boron contents in the Ni—P—B plating layers of the shoes, which plating layers were formed by using the plating liquid which permits the Ni—P—B plating layers to have hardness values required by the compressor shoes and which exhibits high stability for a long time period. The term “turn” means a time period during which an initial amount of nickel included in the electroless nickel plating liquid is gradually reduced to zero in the plating process. In the actual operation, various components such as the nickel and liquid constituting the plating liquid are replenished, so that the amount of nickel in the plating liquid is kept substantially constant. It is noted, however, that the time period during which the initial amount of nickel is consumed is regarded as one turn. Even if the nickel and the other components are replenished, the electroless nickel plating liquid cannot be used permanently. Due to a change in characteristics of the plating liquid, a rate of plating at which the plating layer is formed may be lowered. Further, the plating layer may be undesirably formed on the inner wall of the plating bath or the mass of particles accumulated on the bottom of the plating bath. In this case, it is necessary, for instance, to replace the plating liquid with new one and clean the plating bath. The plating liquid is considered to have high economy if it can be used with high stability even after it has been subjected to a large number of turns with the nickel and the other plating liquid components being replenished. Further, as shown in the graph of FIG. 4, the boron content in the Ni—P—B plating layer inevitably reduces with an increase of the number of turns even if the composition of the plating liquid is kept unchanged by replenishing the nickel and the other plating liquid components.

As is apparent from the results indicated in the graph of FIG. 3, the comparative shoes of the group #3 did not have hardness values required by the compressor shoes. As is also apparent from the results indicated in the graphs of FIGS. 3-5, although the comparative shoes of the group #2 whose Ni—P—B plating layers had the boron contents larger than 0.2 wt. % exhibited hardness values required by the compressor shoes, the plating liquid used for the comparative shoes of the group #2 suffered from deposition of nickel on undesirable portions other than the base body when the number of turns of the plating liquid exceeded 1.5. Namely, the plating liquid was unstable, and the deposited nickel adhered to the plating bath, so that the plating layer having a nominal or stable composition was not formed on the base body of the shoe. The unstable plating liquid cannot be used, and is inevitably discarded. The nickel plating adhering to the plating bath needs to be removed therefrom, resulting in uneconomical plating. In contrast, the shoes of the group #1 according to the present invention had hardness values required for the compressor shoes. In addition, the plating liquid for forming the Ni—P—B plating layers of the present shoes of the group #1 exhibited practically acceptable stability until the number of turns became 5. Accordingly, the hard layer 152, i.e., the Ni—P—B plating layer, can be formed on the base body of the shoe with high stability and high economy if the boron content in the Ni—P—B plating layer is held within the range of 0.05-0.14 wt. % and the Ni—P—B plating layer is not subjected to any heat treatment.

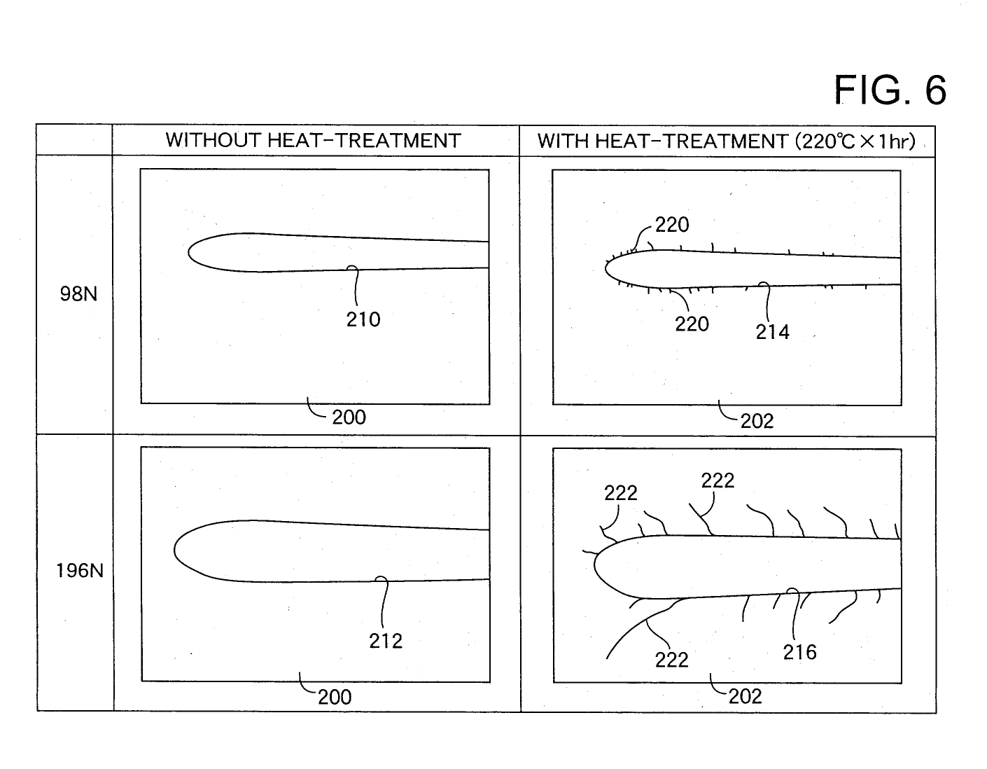

For examining an influence of a heat treatment on the wear resistance of the hard layer 152, a following scratch test was conducted in the following manner. An indentator was pressed against a surface of a test piece in a direction perpendicular to the surface of the test piece, and was linearly moved in a direction parallel to the surface by a predetermined distance while gradually applying a pressing load to the test piece. Scratches formed on the surface of the test piece by the indentator were inspected. A scratch test apparatus used for the scratch test includes the indentator, a holding device for fixedly holding the test piece, a first moving device for moving the indentator toward and away from the surface of the test piece, and a second moving device for linearly moving the indentator in the direction parallel to the surface of the test piece. As the test piece, there was used a plate member formed of an aluminum alloy (A4032) as a base body. The plate member includes 75 μm-thick electroless Ni—P plating layer, and 25 μm-thick electroless Ni—P—B plating layer, which two layers are formed on the surface of the plate member in the order of description. Two plate members (200, 202 shown in FIG. 6) constructed as described above were prepared. The test piece 200 was not subjected to any heat treatment on its electroless Ni—P—B plating layer, like the shoe 76 as the sliding member according to the present invention. The test piece 202 as a comparative example was subjected to a heat treatment at 220° C. for one hour on its electroless Ni—P—B plating layer. The Ni—P plating layers of the test pieces 0.200, 202 contained 8.0 wt. % of phosphorous (P) while the Ni—P—B plating layers of the test pieces 200, 202 contained 2.0 wt. % of phosphorous (P) and 0.1 wt. % of boron (B). The indentator used in the scratch test has a diamond tip having a conical shape, which tip has an apex angle of 120° and a radius of curvature of 0.2 mm. The scratch test was conducted on the two test pieces 200, 202 under the following two conditions:

1) The pressing load acting on the indentator was gradually increased from 0N up to 98N while the indentator was linearly moved on the surface of each of the two test pieces 200, 202 by a distance of 5 mm in one minute.

2) The pressing load acting on the indentator was gradually increased from 0N up to 196N.

The results of the test are indicated in FIG. 6. FIG. 6 shows terminal portions of scratches 210, 212 formed on the surface of the non heat-treated test piece 200 when it received maximum pressing loads (98N and 196N), and terminal portions of scratches 214, 216 formed on the surface of the heat-treated test piece 202 when it received maximum pressing loads (98N and 196N).

As is apparent from the results indicated in FIG. 6, the non heat-treated test piece 200 whose Ni—P—B plating layer had not been subjected to any heat treatment did not suffer from cracks in the vicinity of the scratches 210, 212 formed when the pressing loads applied to the test piece 200 were 98N and 196N, respectively. In contrast, the heat-treated test piece 202 whose Ni—P—B plating layer had been subjected to the heat treatment suffered from cracks 220, 222 in the vicinity of the scratches, 214, 216 formed when the pressing loads applied to the test piece 202 were 98N, and 196N, respectively. As shown in FIG. 6, the cracks 220, 222 generated so as to extend from the respective scratches 214, 216. Very large cracks 222 were observed particularly when the pressing load was 196N. It is assumed that these cracks generated because the deformability of the plating layer was reduced due to the heat treatment although the hardness of the plating layer was increased. During the operation of the compressor, the foreign matters may get in between the sliding surfaces of the shoe 76 and the piston 14, or between the sliding surfaces of the shoe 76 and the swash plate 60. In this case, the same phenomenon as in the above-described scratch test will occur. However, in the present arrangement wherein the Ni—P—B plating layer formed on the surface of the shoe 76 is not subjected to any heat treatment, the scratches of the Ni—P—B plating layer due to the foreign matters will not develop into cracks. Therefore, the peeling of local portions of the plating layer from the base body 146, which would otherwise be caused by the cracks, is effectively avoided, for thereby preventing seizure form taking place between the shoes 76 and the piston 14, or between the shoe 76 and the swash plate 60.

What is claimed is:

1. A sliding member for a compressor, comprising a base body formed of a material which contains aluminum as a major component, and an electroless nickel plating layer formed on a surface of said base body and containing phosphorous (P) and boron (B), wherein the improvement comprises: said electroless nickel plating layer being a non heat-treated layer containing said phosphorous in an amount of 0.5-5.0 wt. % and said boron in an amount of 0.05-0.2 wt. %.

2. A sliding member according to claim 1, wherein said electroless nickel plating layer contains said phosphorous in an amount of 0.5-3.0 wt. %.

3. A sliding member according to claim 1, wherein said electroless nickel plating layer contains said boron in an amount of 0.05-0.18 wt. %.

4. A sliding member according to claim 1, wherein said electroless nickel plating layer contains said boron in an amount of 0.05-0.14 wt. %.

5. A sliding member according to claim 1, wherein said electroless nickel plating layer contains said phosphorous in an amount of 0.5-3.0 wt. % and said boron in an amount of 0.05-0.14 wt. %.

6. A sliding member according to claim 1, wherein said sliding member further comprises an electroless Ni—P plating layer formed between said base body and said electroless nickel plating layer.

7. A sliding member according to claim 5, wherein said sliding member further comprises an electroless Ni—P plating layer formed between said base body and said electroless nickel plating layer.

8. A sliding member according to claim 6, wherein said electroless Ni—P plating layer contains phosphorous in an amount of 5.0-15.0 wt. %.

9. A sliding member according to claim 7, wherein said electroless Ni—P plating layer contains phosphorous in an amount of 5.0-15.0 wt. %.

10. A sliding member according to claim 1, which is a shoe used for a swash plate type compressor.

11. A sliding member according to claim 10, wherein said electroless nickel plating layer contains said boron in an amount of 0.05-0.14 wt. %.

12. A sliding member according to claim 10, wherein said electroless nickel plating layer contains said phosphorous in an amount of 0.5-3.0 wt. % and said boron in an amount of 0.05-0.14 wt. %.

13. A sliding member according to claim 10, wherein said shoe further comprises an electroless Ni—P plating layer formed between said base body and said electroless nickel plating layer.

14. A sliding member according to claim 12, wherein said shoe further comprises an electroless Ni—P plating layer formed between said base body and said electroless nickel plating layer.

15. A sliding member according to claim 13, wherein said electroless Ni—P plating layer contains phosphorous in an amount of 5.0-15.0 wt. %.

16. A sliding member according to claim 14, wherein said electroless Ni—P plating layer contains phosphorous in an amount of 5.0-15.0 wt. %.

17. A sliding member according to claim 1, which is a vane used for a vane compressor.
